(19) United States
(12) Patent Application Publication
(10) Pub. No.: US 2002/0143496 A1
(43) Pub. Date: Oct. 3, 2002

(54) Individual valuation in a group enterprise

(76) Inventors: Edward Mactas, Marietta, GA (US); George Madelil, Roswell, GA (US); Han Liem, Marietta, GA (US)

Correspondence Address: ALLEN N. FRIEDMAN, ESQ., C/O MCCARTER & ENGLISH, LLP, FOUR GATEWAY CENTER, 100 MULBERRY STREET, NEWARK, NJ, 07102, US

(21) Appl. No.: 10/072,350

(22) Filed: Feb. 7, 2002

Related U.S. Application Data
(60) Provisional application No. 60/267,565, filed on Feb. 9, 2001.
(60) Provisional application No. 60/298,561, filed on Jun. 16, 2001.

(51) Int. Cl. G06F 101/14

(52) U.S. Cl. 702/179

(57) ABSTRACT

An economic value is assigned to an individual's contribution to an organization (or a group's contribution to the organization, based on aggregating the contributions of a set of individuals). The valuation metric, called “EVi™” (“Expected Value of the Individual”), represents a measure of human capital value for any individual in an organization. The EVi™ measure, when aggregated for an entire organization, becomes a tool for evaluating the performance of the human capital management system.

### RELATED APPLICATIONS

This Application depends for priority on Provisional Application Ser No. 60/267,565, filed Feb. 9, 2001 and Provisional Application Ser. No. 60/298,561, filed Jun. 16, 2001.

### GOVERNMENT FUNDED RESEARCH

Not applicable

### BACKGROUND OF THE INVENTION

1. Field of the Invention

This invention relates generally to data computation and, more particularly, to computation of valuation metrics for individuals in group enterprises.

2. Description of the Related Art

Organizations have long sought a means of accurately assessing the value of their members or constituency (their “human capital”), both individually and collectively. It is commonplace for organizations to generate a subjective or qualitative valuation of members. Honorary titles, awards, and the like are examples of subjective valuation of individuals to the organization. Examples of organizations that commonly utilize subjective valuations include clubs, athletic teams, and relatively unstructured associations of people. Organizations are also interested in quantitative valuation of their members. In many cases, organizations find it useful to assign a ranking to each member relative to a group of members. For example, sales organizations may rank employees by revenue generated from sales. Other organizations may calculate a quantitative score to indicate the value of an individual or group of individuals to an organization. For example, athletic contestants may have a numerical value assigned to their performance, such as football quarterback index ratings, and employees may have a single numerical score associated with an annual performance appraisal, such as on a scale from 1 to 5.

Companies are especially interested in quantitative measures of human capital because, with such metrics, better allocations of personnel and resources can be more easily identified, and personnel can be better matched to assignments. Moreover, employees often report greater satisfaction when they feel their talents are being utilized. Currently available quantitative measures of the value of an individual (or group) to a business organization may have the appearance of precision and accuracy, but may not provide a realistic indication of the value (and cost) of an individual to the organization. Techniques that are typically used for valuation simply determine particular costs or contributions associated with an individual.

Companies, for example, may assess employee human capital by calculating individual costs such as employee salary and benefits, and may determine individual contribution (revenue) as being equal to a proportional amount of company revenue. This provides a very coarse measure of individual value to the enterprise. Other aspects of quantitatively assessing the value of an individual or group of individuals to an organization go unanswered. If more accurate measures of individual value and of costs were available, business organizations would be better able to allocate their personnel and available resources to increase the efficiency and effectiveness of the organization and increase the satisfaction of the individuals.

Quantitative valuations make it easier, for example, to determine adjustments in employee compensation or benefits or training. For companies, quantitative measures of value are particularly important because such valuations can be used as a baseline for determining the payback (return on investment) for a wide range of human capital and other business investments, including:

Recruiting and selection;

Executive search;

Employment branding;

Learning and training programs;

Diversity programs;

Team-building/structure;

Employee recognition programs;

Performance feedback and career management;

Technology applications;

Reward, equity, and benefit programs;

WorkLife programs;

Workspace design and environment;

Communities of practice;

Employee (or office) relocation;

Telecommuting and alternative work arrangements;

Retention and talent management initiatives;

Workforce planning initiatives;

Employee communications and culture;

Make versus buy decisions (e.g., whether to outsource a function or activity rather than perform it in-house);

Change management;

Customer focus and employee connection;

Relational capital (customers, suppliers, alliance/venture partners and other employees);

Customer relationship management and valuation;

Job design, assignment and role clarity;

Employee-customer service delivery;

Idea capture, innovation and knowledge management tools and processes;

Formation and performance of teams;

Human capital deployment within portfolio and project management systems; and

Other work-related tools and processes.

From the discussion above, it should be apparent that there is a need for providing an improved quantitative measure of an individual's value to an organization. The present invention provides a quantitative approach for measuring an individual's value to an organization.

### SUMMARY OF THE INVENTION

In accordance with the present invention, an economic value is assigned to an individual's contribution to an organization (or a group's contribution to the organization, based on aggregating the contributions of a set of individuals). The valuation metric, which will be referred to hereafter as “EVi”™ (to indicate the novel metric describing a computed expected value of an individual to an organization), represents a measure of human capital value for any individual in an organization. The EVi™ metric, when aggregated for an entire organization, becomes a tool for evaluating the performance of the human capital management system. For example, applications of the EVi™ metric may be used to answer questions such as: Do various activities increase or decrease organizational and individual value? At what rate? In this way, the invention optimizes value for the organization and for the individuals who comprise the organization, and facilitates organizational decision-making and management processes pertaining to people. Also, the EVi™ metric quantifies minimum expected contributions, based on individual data that should be readily available to the organization.

The various features and advantages of the present invention should be apparent from the following description of the preferred embodiment, which illustrates, by way of example, the principles of the invention.

### BRIEF DESCRIPTION OF THE DRAWINGS

FIG. 1 is a flow diagram that illustrates the processing performed in determining individual cost associated with an individual value calculation in accordance with the present invention.

FIG. 2 is a graph that depicts productivity changes due to a departing employee and a replacement employee.

FIG. 3 is a flow diagram that illustrates the processing performed in determining the individual Actuarial Replacement Value.

FIG. 4 is a graph that shows an employee learning curve.

FIG. 5 is a flow diagram that illustrates the processing performed in determining individual revenue associated with an individual value calculation in accordance with the present invention.

FIG. 6 is a flow diagram that illustrates the processing performed in calculating an annual EVi™ number for each individual in accordance with the present invention, using the individual cost and revenue determinations illustrated in FIG. 1, FIG. 3, and FIG. 5.

FIGS. 7A-1 and 7A-2 are sample calculations of Actuarial Replacement Value and Actuarial Revenue Wage Load Factor for two people with different ages, pay levels, lengths of service, etc.

FIG. 7B shows a sample calculation for obtaining the Weighted Average Actuarial Revenue Wage Load Factor (ARWLF).

FIGS. 7C-1 and 7C-2 are sample calculations of iRevenue, iCost, EVi™ and Annual EVi™ for each of the two individuals described in FIGS. 7A-1 and 7A-2.

FIG. 7D shows the set of decrement rates used in the expected working lifetime calculation used in FIGS. 7A-1 and 7A-2 as well as the calculations of risk adjustment used in FIGS. 7C-1 and 7C-2.

FIG. 7E shows a set of probabilities that an employee will be promoted from one job level to another. These probabilities are used in the ARWLF calculation in FIG. 7B.

FIG. 8 is a block diagram of a computer system constructed in accordance with the present invention for performing operations in calculating the EVi™ metric.

FIG. 9 is a block diagram representation of a computer in the system illustrated in FIG. 8.

### DETAILED DESCRIPTION

1. Overview

The following detailed description illustrates the invention by way of example, not by way of limitation of the principles of the invention. This description enables one skilled in the art to make and use the invention. The description is provided in the context of an individual, also referred to as the employee, who is a member of a company or business organization. It should be understood, however, that the invention has application to many different types of organizations and members other than the context of employee and employer.

In accordance with the present invention, a measure of individual value to a group or organization is provided by calculating an expected value of an individual to the group. This measure is referred to herein as the EVi™ value or metric and, when aggregated, it becomes a tool for evaluating the performance of the human capital management system. The EVi™ calculation uses a market-based approach which considers the value set in the external marketplace for the services of individuals or groups of individuals. For individuals, this would include compensation, benefits and training as well as other direct and indirect human capital-related costs. It also focuses on what it would cost the organization to replace a particular individual including such non-obvious costs as early low productivity (learning curve), turnover risks associated with new hires, and other factors, and thereby incorporates actuarial principles to the human capital valuation.

Various techniques have been proposed for human resource valuation. These techniques include, for example, a Stochastic Rewards Valuation Model described by Eric G. Flarnholtz in Human Resource Accounting, 3d ed. (1999) at 180-183. See also a description of a system based on this model, in Human Resource Accounting, 3d ed. at 321-348. The Stochastic Rewards model defines a mutually exclusive set of states in which an individual may reside. The value of each state to the organization is determined. The valuation of the individual then follows from determining the probability that an individual will occupy each state in the future. The sum of the possible service state values then indicates a valuation for the individual.

With respect to business organizations, mathematical models similar to the one described above, typically do not accurately consider an individual's value to the company. For example, the valuations of individuals are a function of the valuations assigned to the enumerated states in which an individual may be assigned. Such valuations arbitrarily assign individuals with a valuation according to a particular step-wise valuation function. Mathematical models also typically do not consider the value that a long-term employee brings to a company, both in terms of greater productivity from the existing employee and in avoiding the decreased productivity that would result from the individual departing from the company. Further, these models do not account for the fact that existing employees are less likely to leave the organization than new employees, increasing the likelihood that a new hire will have to be replaced more than once.

Another valuation technique for companies is the Adjusted Discounted Future Wages method of Roger Hermanson, also in Human Resource Accounting, 3d ed. (1999), by Eric G. Flamholtz, at 213-215. Hermanson uses an individual's company compensation as a surrogate measure of the individual's value to the company. The present value of the individual's future compensation stream is adjusted by an efficiency factor that is determined for the company relative to all other companies in the relevant economy.

While using compensation as a surrogate for value can assist in simplifying the computation process, it typically fails to consider costs and revenues for the individual. Likewise, using a company-wide efficiency factor ignores individual differences and associated costs.

A Compensation Model of Lev and Schwartz, also in Human Resource Accounting, 3d ed. (1999) by Eric G. Flamholtz at 215-217, assumes that the value of an individual to an organization is the present value of the individual's remaining future earnings from employment, based on life expectancies and working years until a specific retirement age.

Compensation models based on work life expectancy do not take into account the likelihood that an individual employee will depart from the company prior to retirement or death. Again, such models will not provide an accurate measure of individual valuation, nor do such models compute a value premium above and beyond compensation that indicates a minimum expected revenue contribution of the individual.

As described further below, the EVi™ technique of the present invention considers the price set in the external marketplace for the services of individuals and includes compensation, benefits and training, as well as other direct and indirect human capital-related costs. The EVi™ technique computes a value for the individual without reference to allocation of aggregate organizational revenue or profit on a per capita or other ratio basis (such as revenue per employee), but rather computes the value directly at the level of the individual and then builds an organizational view of value based on the aggregation of individual values. In this way, the EVi™ metric offers a truly different perspective on the value contributed by individuals to the organization in that it includes opportunity costs and risks associated with forgoing the services rendered by the individual to the organization, neither of which are generally considered in other types of valuations.

The EVi™ technique also focuses on what additional costs the organization would incur in replacing a particular individual, including such non-obvious costs as reduced productivity of the individual who is departing and also the early low productivity (learning curve) of a replacement employee, turnover risks associated with new hires, and other factors. In summary, the EVi™ technique of the invention is more reflective of the true costs that the organization incurs than other methods.

EVi is the minimum expected contribution of an individual to an organization. When aggregated, EVi helps managers understand the minimum value or return that the organization needs to receive from its workforce in order to justify investing in the particular set of individuals that are employed. EVi can also be used as an element in evaluating the effectiveness of various human capital management initiatives so that, for example, retention and redeployment decisions can be made on a more specific basis.

When used in financial ratios, EVi improves on existing metrics that seek to allocate financial performance to the workforce by isolating that aspect of productivity that can be attributed to people. EVi-based metrics can also be compared across companies to determine which enterprises are doing a better job at leveraging their human capital and improving the contribution of the workforce to value creation, enabling the enterprise to better allocate investments in human capital.

Understanding the degree to which a workforce is contributing above and beyond a minimum value (the aggregated EVi) allows organizations to compare different divisions or business units in terms of their success in managing people. Another use might be in determining how well a workforce is being managed at a company that is an acquisition candidate. The information could serve as a valuable input to spinoff or restructuring decisions.

2. The Process of Calculating the EVi™ Value

The individual value metric in accordance with the present invention, called the EVi™ metric, assigns a financial value to individuals in the workplace based on a variety of factors. The EVi™ metric provides a measure of individual employee value, calculated using a combination of actuarial principles and traditional economic valuation principles (applicable to intangibles).

The EVi™ calculation is described as the minimum revenue that an individual is expected to generate over his or her working lifetime minus the cost of that individual over the same period. Both revenue and cost are adjusted to take into consideration the probability of various decrements, including mortality, retirement, disability, and withdrawal, in addition to salary inflation, promotion, and changes in productivity. Adjusted figures are then discounted to reflect the time value of money or a required rate of return. The calculation can be expressed as follows, in its simplest terms, in Equation 1:

EVi=iRevenue−iCost (Eq. 1)

where iCost=the PV of Expected Wages, and iRevenue=the PV of Minimum Expected Revenues. An annualized value of the EVi™ measure of an employee can be derived by dividing the EVi™ metric by the expected working lifetime of the employee.

Throughout this document a number of terms are used interchangeably: Revenue, Rev, and R; Wage and W; and Cost and C.

2.1 iCost

Individual Cost (iCost) is the Present Value (PV) of Expected Wages. Wage (W) includes compensation, benefits, training and other direct and indirect human capital-related costs. Wages are computed using the company's historical employment and human capital records. Projecting future compensation and benefits can be accomplished in a fairly straightforward manner employing accepted Actuarial Standards of Practice (e.g., ASOP 27). Assumptions are made regarding both wage and productivity increases over the course of an employee's expected working lifetime (ewl). For items unrelated to pay, assumptions are made regarding future inflationary changes. These assumptions are based on company data, industry data, and economic benchmarks. The employee's expected working lifetime (from current age “x” to employee departure) is given by Equation 2:

$$ewl = {\sum }_{n = 1}^{RET - x} n {p}_{x} = {\sum }_{n = 1}^{RET - x} \{ {\prod }_{t = x}^{x + n - 1} ( 1 - {q}_{t}^{w} - {q}_{t}^{r} - {q}_{t}^{d} - {q}_{t}^{i} ) \} \qquad ( Eq . 2 )$$

where:

(a) ₙpₓ is the probability that an employee of current age x is still employed n years later;

(b) qₜ^{w} is the probability that the employee will terminate (i.e., withdraw from the organization) in the interval [t, t+1];

(c) qₜ^{r} is the probability that the employee will retire in the interval [t, t+1];

(d) qₜ^{d} is the probability that the employee will die in the interval [t, t+1];

(e) qₜⁱ is the probability that the employee will become disabled in the interval [t, t+1]; and

(f) RET-x is the duration in years from current age x to last possible departure date (e.g., the number of years from employee's current age to retirement at age 65). Thus, the index n varies from 1 (the first year from the present time, which is the measurement date) to RET-x, defining the measurement interval. Equation 2 assumes that decrements (retirement, termination, death or disability) occur at the beginning of the year. But alternative assumptions, like mid-year or end of year decrements could also be used.

The Wage (Wₙ) of an employee at time “n” (n years after current age x) takes into account increases in compensation, benefits, training, and other direct and indirect human capital-related costs. The expected cost E(Cₙ) of an employee at time “n” is the Wage (Wₙ) adjusted by risk, which includes withdrawal (q^{w}), retirement (q^{r}), death (q^{d}), and disability (qⁱ) as given by Equation 3 below:

E(Cₙ)=Wₙ×ₙpₓ×(1−qₓ₊ₙ^{w}−qₓ₊ₙ^{r}−qₓ₊ₙ^{d}−qₓ₊ₙⁱ) (Eq. 3)

Risk is evaluated from company data, industry data, and actuarial tables. These demographic assumptions are set based on guidelines supplied in the Actuarial Standards of Practice (e.g., ASOP 35). The expected cost E(Cₙ) is then discounted at a specific hurdle rate or required rate of return (r) (e.g., the company's cost of capital). Thus, “iCost” is the sum of these discounted expected costs, as given by Equation 4 below:

$$iCost = {\sum }_{n = 0}^{RET} E ( {C}_{n} ) \times {v}^{n} = {\sum }_{n = 0}^{RET} {W}_{n} {\times }_{n} {p}_{x} \times ( 1 - {q}_{x + n}^{w} - {q}_{x + n}^{r} - {q}_{x + n}^{d} - {q}_{x + n}^{i} ) \times {v}^{n} \qquad ( Eq . 4 )$$

where

$$v = \frac{1}{1 + r} .$$

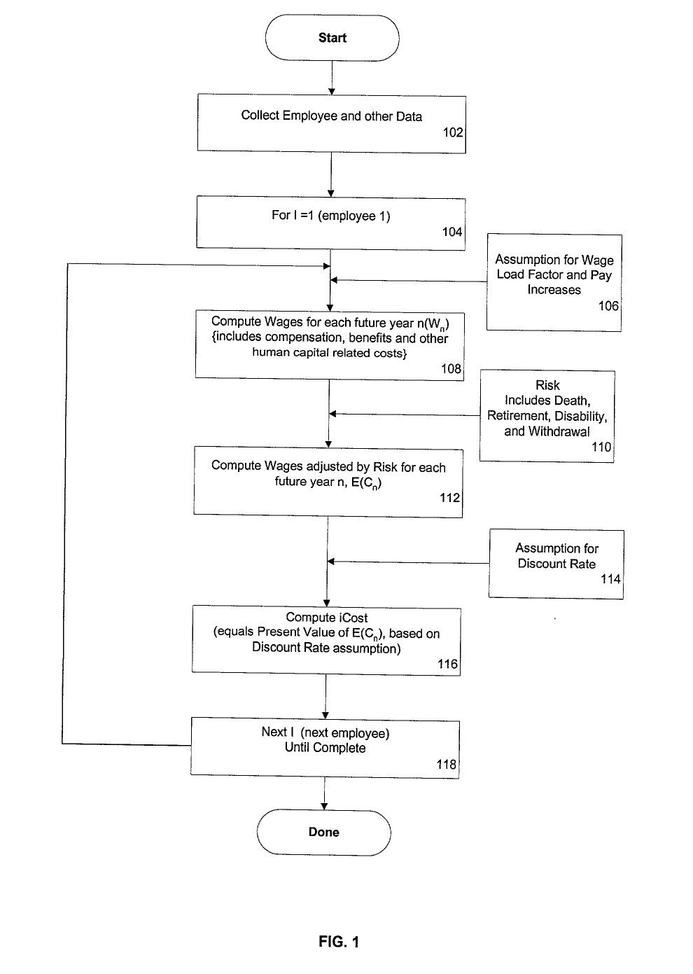

FIG. 1 shows the process for calculating iCost for each individual in an organization, where the organization is a company and the individuals comprise the employees of the company.

In the preferred embodiment, the calculation of the EVi™ metric and its components iCost and iRevenue are performed by a computer processing system in which a computer processor retrieves individual data from a database and, in response to the data and to operator input, automatically performs the calculations necessary to produce the EVi™ valuation metric described further below.

In the first calculation operation, indicated by the FIG. 1 flowchart box numbered 102, data for the individual under consideration and all other persons (employees) in the organization are collected. As described further below, such data may include employee wages, cost of individual employee benefits, and other costs of human capital for the organization that can be attributed to the individual.

The flowchart of FIG. 1 shows the processing where all employees of a company are being considered, in turn. Therefore, iCost will be calculated for each employee. The flowchart box numbered 104 indicates a processing loop for processing data concerning each of the employees in the company, beginning with the first employee to be considered. Next, indicated at box 106, the processing incorporates assumptions for pay increases and load factor (to include benefits, training and other direct and indirect human capital-related costs). The assumptions will be selected by the system designer or at run time, and may include, for example, wage increases due to inflation, promotions, and the like. The next operation, represented by the flow diagram box numbered 108, involves computing wages W for each future year n such that the wages in year n, Wₙ, includes the assumptions retrieved from the box 106 operation.

The next processing box, box 110, indicates that the processing system retrieves data relating to risk factors of the employee that include death while still employed by the organization, retirement, disability, and withdrawal (departure from the organization). This data is retrieved from the database or otherwise provided by the system user. The next operation, specified by the flowchart box numbered 112, involves calculating the wage for the employee under consideration for each year during the employee's potential working lifetime. This is the calculation described above for Equation 3.

Next, in the flowchart box numbered 114, the system retrieves information from the database relating to assumptions for a discount rate. Typical values and assumptions involved in selecting a discount rate will be familiar to those skilled in the art. With the computed wages adjusted for risk and with the assumptions for discount rate, at box 116 the system can compute the iCost value for the individual employee as specified above for Equation 4.

At the flowchart box numbered 118, the system processing returns to the beginning of the processing loop (following box 104) for each employee, so that the iCost processing loop is completed after all employees (or other individuals under consideration in the group) have been processed.

2.2 Actuarial Replacement Value and iRevenue

Individual Revenue (iRevenue) is the Present Value of Minimum Expected Revenues. Each individual in a company possesses a unique set of skills and experiences which endures for a specific period of time and which should equate to a unique expression of value. However, the method for computing this value has not moved much beyond theory, lacking a practical basis for determining how to assign a specific value to a specific individual. The major components of iRevenue defined in this invention provide a practical way of relating value to specific individuals, resulting in a unique EVi™ value for each employee.

Calculating iRevenue is more complicated than calculating iCost because generally the actual revenue an individual will generate cannot be directly calculated. There have been numerous attempts at approximating future revenue of an individual. At the very least, employees are expected to make back “Wage” as described above. But employees generate something above and beyond these costs. For example, people who have been with their organizations for longer are on average more valuable than those who have been there for less time. They know who and where to go to get what they need and how to get things done. This is what is meant by company-specific knowledge. If they have been working for some time, it is also likely that their competencies are important for creating the products and services that customers demand. If their competencies are relevant to customers, they are also likely to be relevant in the industry, increasing their value both to the company and in the marketplace.

One approach to reflecting the additional revenue stream above and beyond wages that employees generate is called “Replacement Cost.” This approach states that each employee generates, at a minimum, additional revenue equal to the cost it would take to replace that employee. To reflect these types of value which capture the premium above and beyond wages that employees generate, the present invention uses a proxy which is captured in a definition of Replacement Cost unique to the EVi™ technique that will be referred to as Actuarial Replacement Value (ARV). The ARV term contains a component for calculating Replacement Cost that relies on actuarial principles and thus distinguishes itself from other approaches for calculating Replacement Cost. When calculating ARV, a blend of company-specific as well as industry metrics are used to approximate a market assessment of an individual employee's expected value. Specifically, ARV is an estimate of the minimum value premium above and beyond “Wage” that should be expected from a fully productive employee, taking into account the importance placed on certain skills in a given industry and the influence of supply and demand (i.e., the employee's ARV rises as the demand for certain skills rises and as the supply of those skills falls).

2.2.1 The Components of ARV

The preferred embodiment includes four major components in calculating the ARV of an employee, which are: (1) dollar-based staffing costs and separation costs (RV1); (2) time-based low productivity costs (RV2); (3) time-based job vacancy costs (RV3); and (4) new hire risk costs (RV4). These are discussed below.

(1) Dollar-Based Staffing and Separation Costs

These costs are relatively straightforward. Unlike other components of ARV, they are not dependent on the number of days a position is unfilled or the number of days it takes an employee to become fully productive. These costs can be divided into two sub-components:

(a) Staffing Costs: cost per hire (advertising, interviewing and other internal recruiting and selection costs, referral bonus, outside search and agency fees, travel and relocation, sign on bonus, etc.) and the cost of training and orientation for new hires.

(b) Separation Costs: administrative costs due to separation, and post-employment costs. Some of the elements of Dollar-Based Staffing and Separation Costs are dependent on Wage and can be expressed as a percentage of Wage, in a variety of ways:

RV1=Staffing Costs+Separation Costs

RV1=Costs (independent of Wage)+Costs (dependent on Wage)

RV1=Costs (independent of W)+%(W)

The next component of ARV involves time-based costs.

(2) Time-Based Low Productivity Costs

During the transition period (the period beginning with the decision that a particular individual is leaving an existing position and ending with the point at which a replacement is fully productive), the business suffers from two types of low productivity:

(a) Existing employee pre-separation low productivity: The period of time during which an individual remains in a position prior to separation and is not as productive as s/he was prior to the decision to leave.

(b) New hire low productivity (learning curve): The period of time during which the new hire needs to be formally or informally trained and “brought up to speed.”

An objective of the novel technique is to express the minimum expected value premium (expressed as ARV) generated by the individual over and above his or her Wage. It is assumed that the existing employee's replacement will be equivalent to the existing employee in terms of his or her knowledge base and skill level. This assumption is consistent with the distinction that has been made in the human resource accounting literature between positional and personal replacement. Positional replacement is distinguished from personal replacement primarily by the scope of activities that are replaced. In the former, only the activities required by the given position are replaced. In the latter, all activities that are delivered by the person are considered. The replacement scope that has been defined—the knowledge base, skill level, length of experience and other demographic characteristics—is not limited to a position and is therefore consistent with the notion of personal replacement.

It is also assumed that it is not possible to hire this new employee for less, nor will it be necessary to pay more. For this reason, it is assumed that the existing employee and the replacement or new employee have the same Wage. This makes it reasonable to combine the low productivity caused by an exiting employee with that of the new hire for purposes of computation.

To estimate the value that is lost to the company due to time-based low productivity, a fully productive employee is compared with an unproductive employee.

A fully productive employee generates Revenues (Rev), and costs the company Wage (W), yielding Rev−W. An unproductive employee does not generate Revenues but still costs Wage, yielding 0−W. The difference between the fully productive employee and the unproductive employee can be expressed as [(Rev−W)−(0−W)]=Rev.

But once again, Revenues cannot be directly calculated. Because, as noted earlier, an employee is assumed at the very least to earn back what he or she is paid in compensation, benefits training and other direct and indirect human capital-related costs, Wage is used at this stage as a conservative (low) proxy for Revenues. Wage is then adjusted by the same required rate of return used in iCost calculations. This adjustment treats the investment in human capital similarly to other capital investments and will ultimately permit the EVi™ measure to be compared with other ROI computations. The “Required Rate of Return Adjusted Wage” is an estimate of the Revenues that are affected by early low productivity.

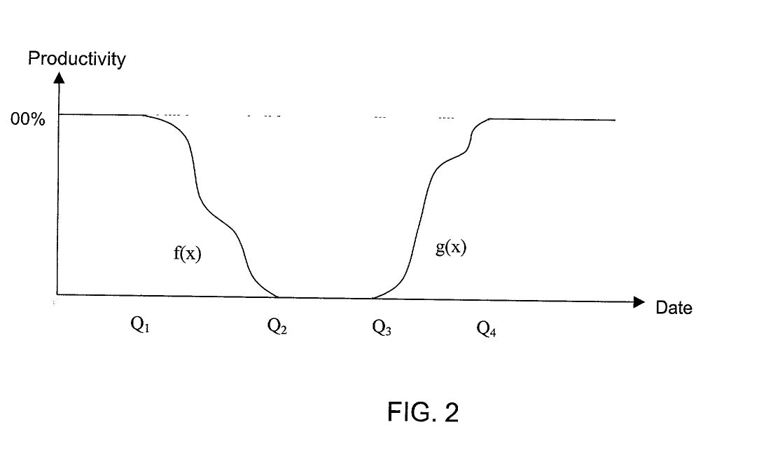

The two forms of low productivity (pre-separation and new hire) may be approximated by functions that follow curves (decreasing for the existing employee, increasing for the new hire) such as the ones illustrated in FIG. 2. The curves of FIG. 2 show elapsed days over period of time intervals designated by Q₁, Q₂, Q₃, and Q₄. The productivity reduction attributable to the departing employee is shown by the function f(x), while the productivity increase attributable to the new employee is shown by the function g(x). Those skilled in the art will be able to generate these functions, using empirical knowledge about the particular organization involved and generally accepted data concerning human resource management.

(c) Computing Low Productivity Costs: Next, the elapsed days of both forms of low productivity must be converted into a corresponding number of unproductive days. The technique of the present invention computes this number in two steps.

### Step 1

### Existing Employee Pre-Separation Low Productivity

In this step we measure the loss of productivity of the existing employee from the time the employee decides to leave (Q₁, FIG. 2) and the actual date of termination (Q₂, FIG. 2). Mathematical integration is used to convert elapsed days of low productivity into actual days (Pre-Separation Full Productivity or PSF) of full productivity (an equivalent length of time during which full revenues are generated). This can be expressed in Equation 5 as:

$$PSF = {\int }_{{Q}_{1}}^{{Q}_{2}} f ( x ) ⅆ x \qquad ( Eq . 5 )$$

where f(x) is a decreasing function that represents the productivity of the existing employee. The number of actual days of nonproductivity is then given by Pre-Separation Nonproductivity or PSN in Equation 6:

PSN=(Q₂−Q₁)−PSF (Eq. 6)

where (Q₂−Q₁) represents the number of days in the period from Q₁ to Q₂.

### Step 2

### New Hire Low Productivity Due to Learning Curve

Different jobs have different “ramp up” curves that are often dependent on the complexity of the position. These curves, generally referred to as learning curves, can be expressed as a function of the elapsed days of low productivity. The curve g(x) in FIG. 2 is an example of a learning curve. For example, the function g(50)=0.75 indicates that a new hire on the 50th day of employment is 75% productive.

To calculate low productivity, the level of productivity of the new employee from date of hire (Q₃) to the date of full productivity (Q₄) is measured. The term (Q₃−Q₂) represents the number of days the position is vacant. The impact of vacancy is measured in the next component of ARV. Mathematical integration is again used, this time to convert elapsed days of low productivity into actual days (Learning Curve Full Productivity or LCF) of full productivity (an equivalent length of time during which full revenues are generated). This can be expressed as follows in Equation 7:

$$LCF = {\int }_{{Q}_{3}}^{{Q}_{4}} g ( x ) ⅆ x \qquad ( Eq . 7 )$$

where g(x) is an increasing function which represents the productivity of the new employee. The actual days of nonproductivity (Learning Curve Nonproductivity or LCN) are then given by Equation 8:

LCN=(Q₄−Q₃)−LCF (Eq. 8)

where (Q₄−Q₃) represents the number of days in the period from Q₃ to Q₄. Total unproductive days can therefore be expressed as in Equation 9:

D₁=PSN+LCN (Eq. 9)

Thus the element of ARV that can be attributed to low productivity can be expressed as:

$$\begin{matrix}RV 2 = [ \frac{{D}_{1}}{365} ] \times [ Revenues ] & ( Eq . 10 ) \\ RV 2 = [ \frac{{D}_{1}}{365} ] \times [ W \times ( 1 + r ) ] & ( Eq . 11 )\end{matrix}$$

where D₁ represents total unproductive days and r is the internal required rate of return.

(3) Time-Based Job Vacancy Cost

Continuing to build the measure of the minimum expected value premium above and beyond Wage that is generated by an existing productive employee, the next component is the amount of time on average that an existing position remains vacant.

To estimate the value that is lost to the company due to vacancy, the invention compares a fully productive employee to no employee. As noted above, the fully productive employee generates Revenues (Rev) and costs the company Wage (W), yielding Rev−W. If the company does not have an employee in the position, there are no Revenues and no Wage. The difference between these two employees is thus Rev−W, or Profit.

At this stage of the process, the novel technique assumes that the best estimate of the minimum expected value premium generated by a fully productive employee consists of the opportunity cost or minimum expected value premium forgone when the company replaces that fully productive employee with an equivalent employee, expressed as the sum of Dollar-based Staffing Costs and Separation Costs (RV1) and Time-based Low Productivity Costs (RV2). Computationally, this sum is used as a proxy for Profit based on the assumption that:

Cost=Wage

Revenues=Wage+Current Proxy for ARV, (RV1+RV2)

The Profit can then be computed as follows:

Profit=Revenues−Cost (Eq. 12)

Profit=[Wage+(RV1+RV2)]−Wage (Eq. 13)

Profit=RV1+RV2 (Eq. 14)

Having calculated a proxy for Profit, the Vacancy Cost (RV3) can be expressed as follows:

$$\begin{matrix}RV 3 = [ \frac{{D}_{2}}{365} ] \times [ Profit ] & ( Eq . 15 ) \\ RV 3 = [ \frac{{D}_{2}}{365} ] \times [ RV 1 + RV 2 ] & ( Eq . 16 )\end{matrix}$$

where D₂ represents the number of days a position is vacant.

(4) New Hire Risk Cost

New Hire Risk Cost is a component of ARV that reflects the opportunity cost of the minimum expected value premium attributable to the risk of new hires compared with existing employees. Specifically, it is recognized that new hires are more likely to leave the organization, compared with existing employees. In other words, the expected working lifetime of a new hire (ewl₂) is effectively shorter than that of a current employee (ewl₁). Thus, more than one new hire may be required to replace an existing fully productive employee. To estimate the minimum expected value premium generated by the existing employee relative to the new hire, the novel technique in accordance with the invention starts with the current proxy for this minimum expected value premium, RV1+RV2+RV3. Then, this proxy is adjusted by the necessary number of additional employees hired to replace the existing employee in terms of their expected working lifetime.

To compute this adjustment factor, the novel technique of the invention uses actuarial principles that consider all possible decrements (e.g., death, disability, turnover, retirement, etc.) that affect expected working lifetime for the demographic group of which the existing employee is a member. With these principles, the expected working lifetime of the existing employee (ewl₁) and of the new hire (ewl₂) are expressed. The ratio of these expected working lifetimes minus one yields the number of additional employees that must be hired to replace the existing employee, in Equation 17:

$$[ \frac{{ewl}_{1}}{{ewl}_{2}} - 1 ] \qquad ( Eq . 17 )$$

Thus this component of ARV, called RV4, can be expressed as follows:

$$RV 4 = ( RV 1 + RV 2 + RV 3 ) \times [ \frac{{ewl}_{1}}{{ewl}_{2}} - 1 ] \qquad ( Eq . 18 )$$

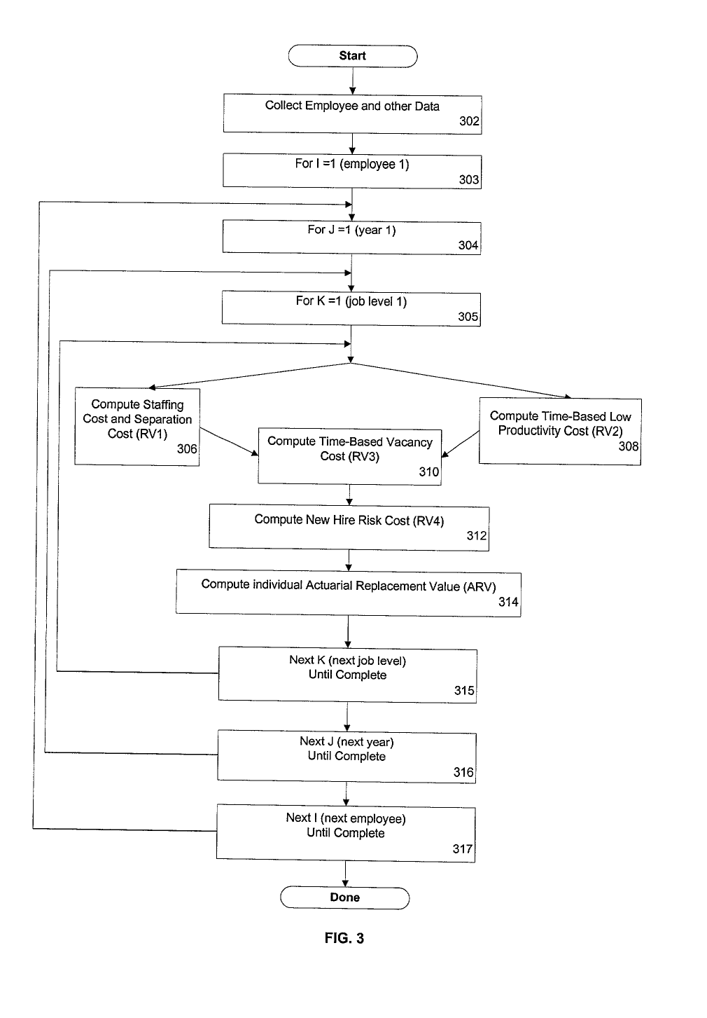

FIG. 3 shows the process for calculating ARV, indicating that it includes the computation of staffing cost and separation cost, low productivity cost, time-based vacancy cost, and new hire risk cost.

FIG. 3 illustrates the processing of the preferred embodiment that helps provide a more useful and accurate expected valuation of an individual. As noted above, one of the shortcomings of previous employee valuation systems has been a lack of considering a variety of replacement costs that are associated with employees who leave or depart the organization before the expiration of their expected working lifetime. The present invention ensures that such costs are considered when the cost of replacing an employee is calculated. This becomes part of the valuation of the existing employee.

The first operation for calculating ARV, as indicated by the flow diagram box numbered 302, is to collect data relating to the individual(s) under consideration, typically meaning all the employees in an organization. With respect to the ARV calculation, the collected data relates to administrative costs associated with the departure of an employee, costs in the form of reduced productivity, costs incurred because a position is vacant, and costs in the form of reduced productivity from new employees in a new job filling the position of the departed employee. Thus, the processing of ARV proceeds as follows.

The flowchart box numbered 303 indicates the start of a processing loop for the computer system, beginning with a first employee (I=1). Box 304 starts a processing loop beginning from current year to the employee's last possible departure year. Box 305 starts another processing loop beginning from the employee's current job level to the highest job level. The next group of flowchart boxes indicates cost processing for each employee under consideration for the valuation metric. The flow diagram box numbered 306 indicates that staffing cost and separation cost will be calculated. This processing involves the calculation of costs incurred by the organization when the individual under consideration departs. In the preferred embodiment, the database from which this information is retrieved contains information that relates to the particular individuals under consideration. For example, the staffing costs and separation costs for a Director will typically be higher than staffing costs and separation costs associated with an employee filling a position for which the company has hundreds of similar positions.

The next processing operation, carried out for each employee under consideration, is to compute time-based low productivity costs associated with a departing employee. This is indicated by the flow diagram box numbered 308. The calculation of this cost is specified above in the discussion relating to Equation 11. The system also performs operations specified by the box numbered 310, which shows the computation of time-based vacancy costs. These costs consider the value that an established or long-time employee brings to the organization, in terms of greater efficiency and increased value versus a new employee. As explained above, when a position held by an established employee is vacant because that established employee has departed from the company, the foregone profit is expressed as the sum of the two previously calculated cost components, RV1 and RV2, multiplied by the time period for which the position is vacant. This value is specified above by Equation 16. The database of the system should be provided with sufficient data to carry out these calculations.

Computing the last component of ARV, illustrated by the flowchart box numbered 312, involves computing the new hire risk cost. This term is expressed as the sum of the prior computed cost components, RV1, RV2, and RV3, multiplied by a factor that takes into account the expected working lifetime of the new hire in the company and the expected working lifetime of the current employee (the employee under consideration). This computation is given by Equation 18 above.

2.2.2 Calculating ARV

Finally, to calculate ARV, each of the components outlined above are added together: ARV=RV1+RV2+RV3+RV4. The processing to compute the ARV term is represented by the FIG. 3 flow diagram box numbered 314. Finally, the boxes numbered 315, 316, 317 indicate that the processing of ARV is repeated for each job level, year, and individual in the organization under consideration. The components and computation of ARV are illustrated by an example given in FIGS. 7A-1 and 7A-2, described further below.

Once ARV is calculated, the next step is to calculate the minimum expected revenue of an individual.

2.2.3 Calculating Minimum Expected Revenue and iRevenue

The Minimum Revenue (Rₙ) of an individual in a year “n” is given by Rₙ=Wₙ+ARVₙ and may be written as Equation 19:

Rₙ=Wₙ+ARVₙ=Wₙ×ARWLFₙ (Eq. 19)

Equivalently,

ARWLFₙ=1+[ARVₙ÷Wₙ] (Eq. 20)

This revenue (Rₙ) is adjusted to take into account the probability that the individual will remain employed, the probability of advancement, and the productivity of the individual during the year n.

The Expected Revenue of an individual in the year n, denoted by E(Rₙ), is given by Equation 21:

$$E ( {R}_{n} ) = {W}_{n} {\times }_{n} {p}_{x} \times ( 1 - {q}_{x + n}^{w} - {q}_{x + n}^{r} - {q}_{x + n}^{d} - {q}_{x + n}^{i} ) \times {pf}_{n} \times {\sum }_{j = c}^{t} {P}_{n} ( j ) \times {ARWLF}_{n} ( j ) \qquad ( Eq . 21 )$$

where x is the individual's current age (at the measurement date), ₙpₓ is the probability of the employee remaining employed from current age x to year n, Pₙ(j) is the probability of an employee being in Job Level j in year n, c is the employee current job level, t is the number of job levels, ARWLFₙ(j) is the Actuarial Revenue Wage Load Factor of the employee in Job Level j in year n, and pfₙ is the productivity factor of the employee in year n.

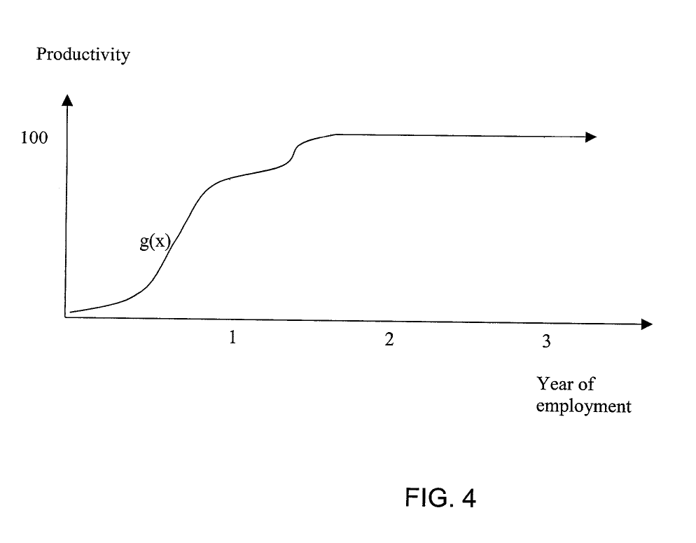

The productivity factor is included because in some cases an employee may leave a position before he or she is fully productive (i.e., before the learning curve is complete). In addition, employees might actually not be able to contribute at their maximum productivity for reasons such as personal commitments, sickness etc. Thus, the productivity factor can be used to consider absences and other factors that impact employee productivity prior to and after becoming a fully productive employee. The graph provided in FIG. 4, where the function g(x) shows the slow rise in productivity due to the learning curve.

For all employees beyond the learning curve, the productivity factor pfₙ is equal to 1. But for employees in the learning period, this factor is typically estimated using mathematical integration as follows:

$${pf}_{1} = {\int }_{0}^{1} g ( x ) ⅆ x , \\ {pf}_{2} = {\int }_{1}^{2} g ( x ) ⅆ x ,$$

pf₃=1,

where g(x) is an increasing function which represents the productivity of the employee during the learning period. An adjustment factor is then applied to the productivity factor to reflect reduction in productivity due to sickness, absences etc.

Finally, the iRevenue term is the sum of the discounted E(Rₙ), using the same discount rate r that is used for the iCost calculation.

$$\begin{matrix}iRevenue = {\sum }_{n = 0}^{RET} E ( {R}_{n} ) \times {v}^{n} \\ = {\sum }_{n = 0}^{RET} {W}_{n} {\times }_{n} {p}_{x} \times ( 1 - {q}_{x + n}^{w} - {q}_{x + n}^{r} - {q}_{x + n}^{d} - {q}_{x + n}^{i} ) \times \\ {pf}_{n} \times {v}^{n} \times {\sum }_{j = c}^{t} {P}_{n} ( j ) \times {ARWLF}_{n} ( j )\end{matrix} \qquad ( Eq . 22 )$$

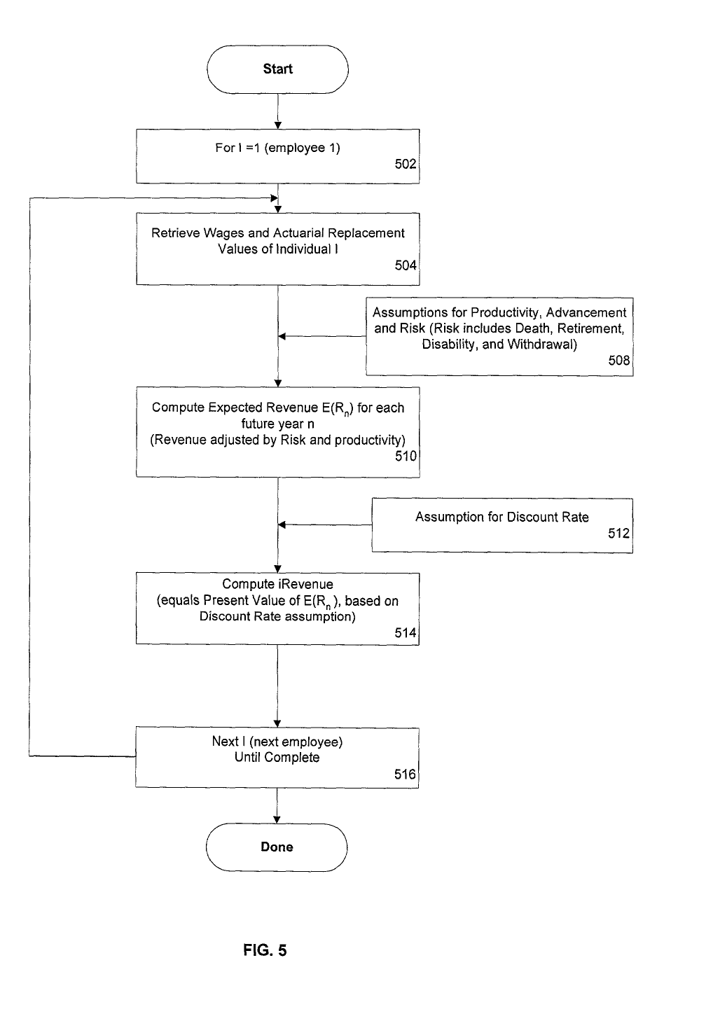

FIG. 5 shows the process for calculating iRevenue for the individuals in an organization.

The first flow diagram box of FIG. 5, numbered 502, indicates the beginning of a processing loop for each employee of the organization under consideration. Next, at box 504, the computer processing system of the preferred embodiment retrieves wage and ARV data for the individual presently under consideration. Some of this data is retrieved from the system database that might be maintained, for example, as an employee records database. Other items of data are the result of computational processing, such as the operations described above for calculating the ARV for each individual employee.

At box 508, the system takes into account risk terms for death, retirement, disability, and early withdrawal or departure of the employee from the organization. In addition it also takes into account the individual employee's probability of advancement and a productivity factor. The risk accounting may be processed, for example, by generating a multiplier to the employee revenue terms for each year. With ARV for each year (and possible job levels), risk factor data, productivity factor, and probability of advancement, the system computes the expected revenue for the employee. The calculation of expected revenue E(Rₙ) given by Equation 21 is represented by the flow diagram box numbered 510.

The system next calculates the iRevenue quantity, comprising present value of E(Rₙ). Therefore, in box 512, the processor retrieves discount rate information from the database. At box 514, the iRevenue term is calculated. At box 516, the iRevenue processing is repeated for each individual in the organization.

2.3 Computing the EVi™ Metric

The Minimum Expected Profit E(Pₙ) of an individual in year n is the expected revenue of the individual in year n minus the expected cost of the individual in year n. As indicated in Equation 23, the E(Pₙ) will also be referred to as iProfit.

iProfitₙ: E(Pₙ)=E(Rₙ)−E(Cₙ) (Eq. 23)

The Net Present Value (NPV) of Profit of an individual, in accordance with the technique of the present invention, is referred to as the EVi™ metric, and is given by Equation 24:

$$\begin{matrix}EVi = {\sum }_{n = 0}^{RET} E ( {P}_{n} ) \times {v}^{n} = {\sum }_{n = 0}^{RET} [ E ( {R}_{n} ) - E ( {C}_{n} ) ] \times {v}^{n} \\ = {\sum }_{n = 0}^{RET} E ( {R}_{n} ) \times {v}^{n} - {\sum }_{n = 0}^{RET} E ( {C}_{n} ) \times {v}^{n} \\ = iRevenue - iCost\end{matrix} \qquad ( Eq . 24 )$$

3. Annual EVi™

“Annual EVi” of an individual will be defined as the EVi™ metric value of the individual divided by the expected working lifetime of the individual (ewl), as given by Equation 25 below:

Annual EVi=EVi/ewl (Eq. 25)

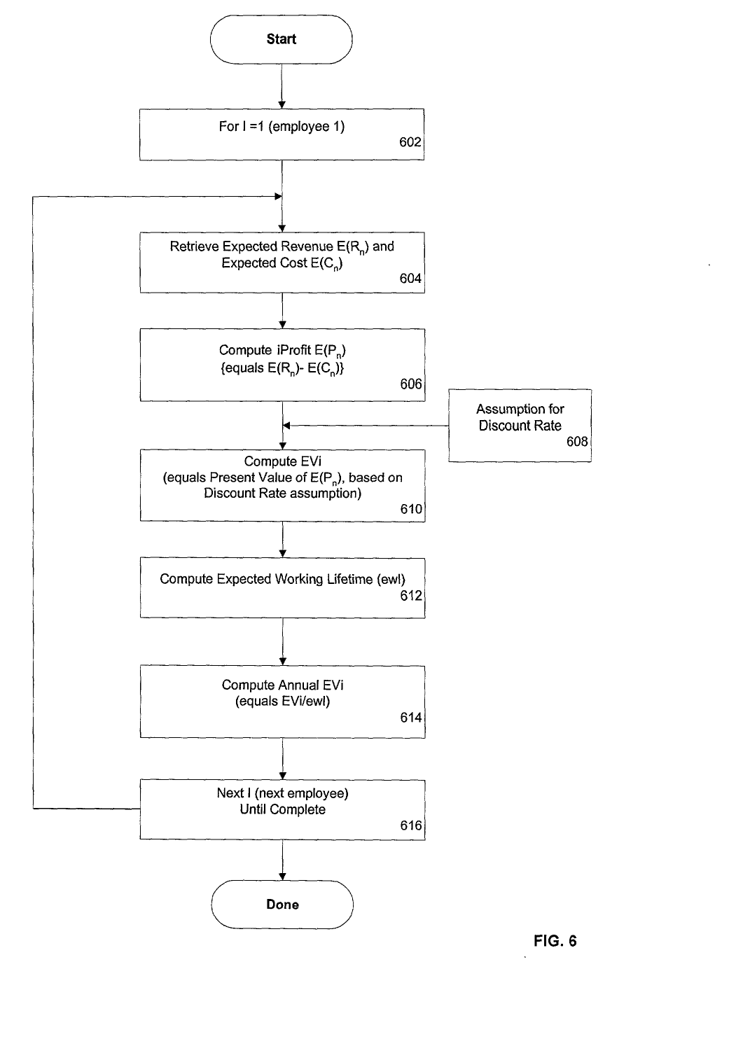

FIG. 6 shows the process for calculating iProfit, the EVi™ metric, and Annual EVi™ in accordance with the invention.

In FIG. 6, the first operation (box 602) indicates that the processing is to be repeated for each individual in the organization. In box 604, the expected revenue E(Rₙ) and expected cost E(Cₙ) are retrieved. The values for E(Rₙ) and E(Cₙ) may be computed for each individual in the group and then stored in a database, to be retrieved later, or the values may be computed from data during the EVi™ processing and retrieved in that way. The calculation of E(Cₙ) is given by Equation 3 above. The next processing for the EVi™ measure, represented by box 606, is to compute the expected iProfit value E(Pₙ) given by the difference of expected revenue E(Rₙ) and expected cost E(Cₙ), in accordance with Equation 23.

Calculating the EVi™ measure involves a net present value computation, and therefore box 608 indicates that the system retrieves data regarding a discount rate. This data will be familiar to those skilled in the art. In box 610, the system computes the EVi™ measure, equal to the present value of iProfit. The next processing operation, box 612, computes expected working lifetime (ewl) of the individual under consideration. Box 614 specifies the next operation, the computation of annual EVi™, which is equal to the EVi™ measure for the individual under consideration divided by ewl for the individual under consideration. Finally, box 616 indicates that the EVi™ processing is repeated for each employee.

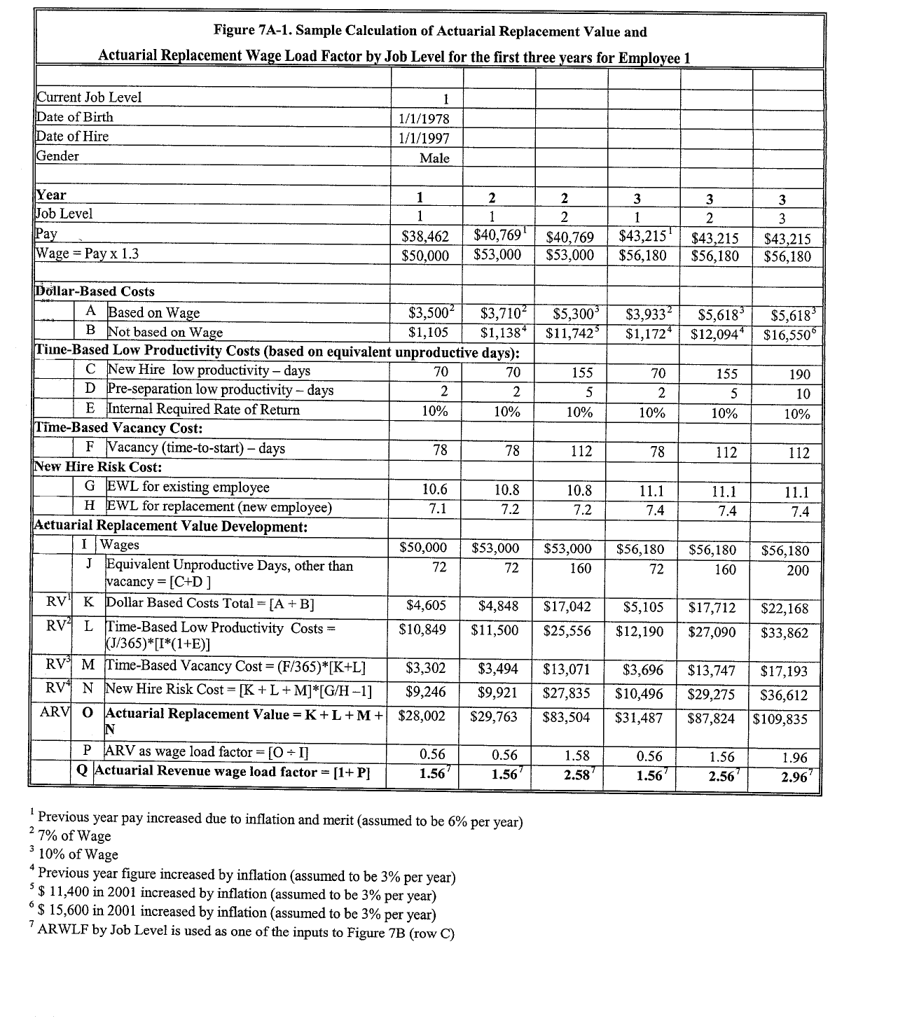

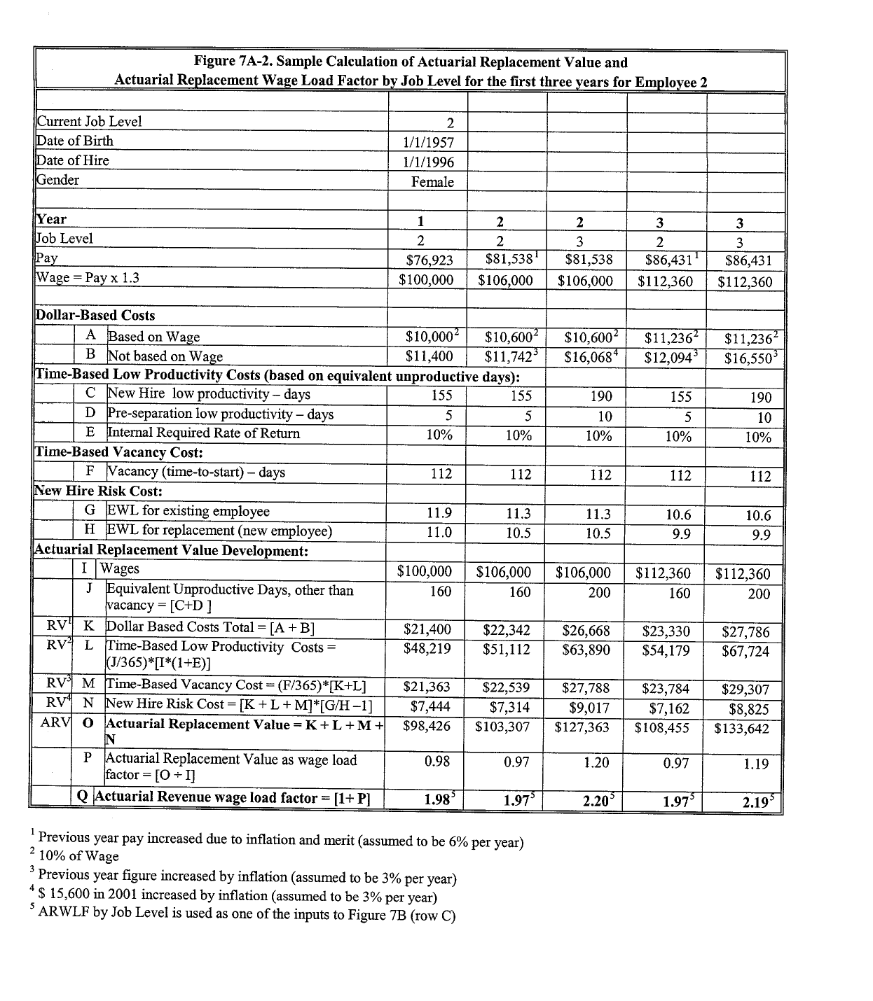

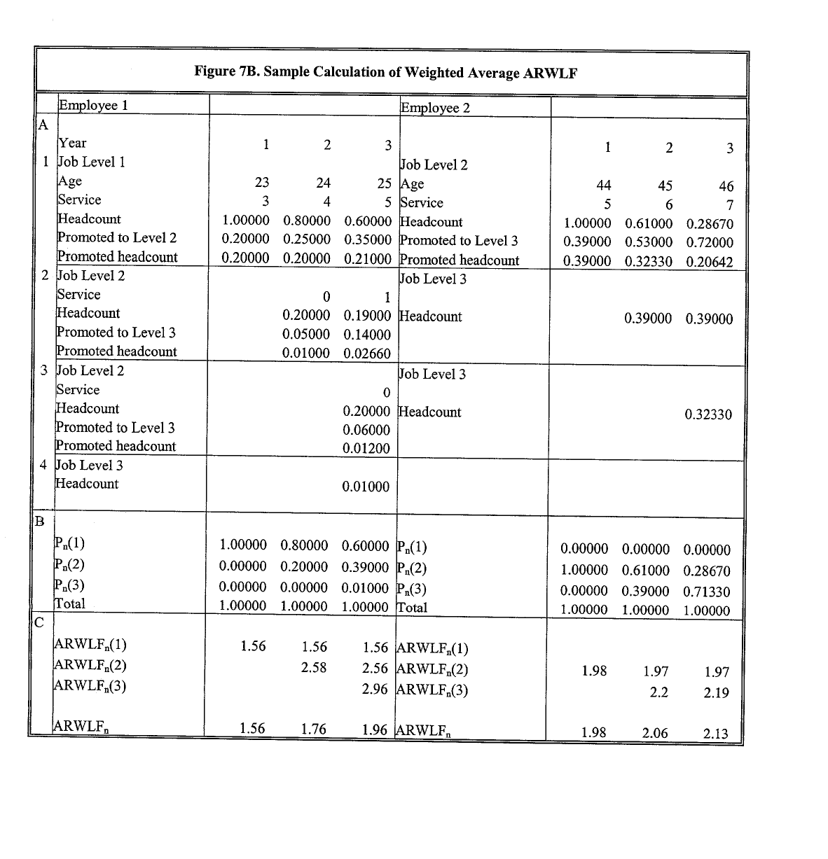

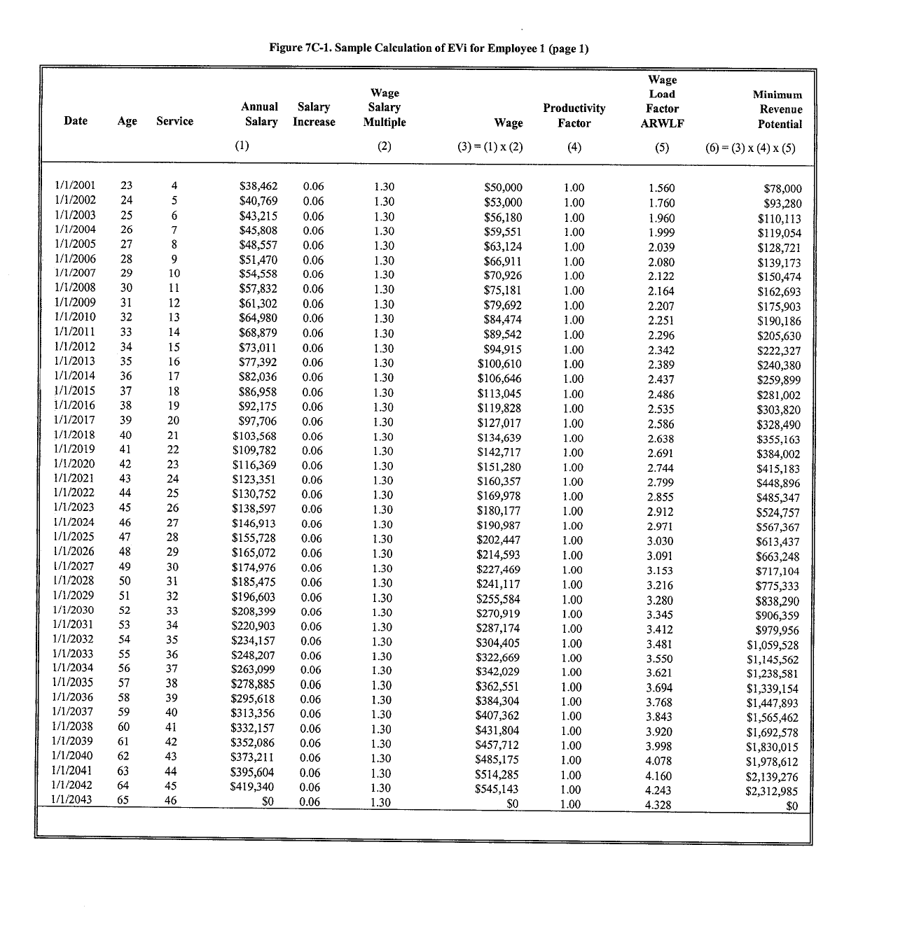

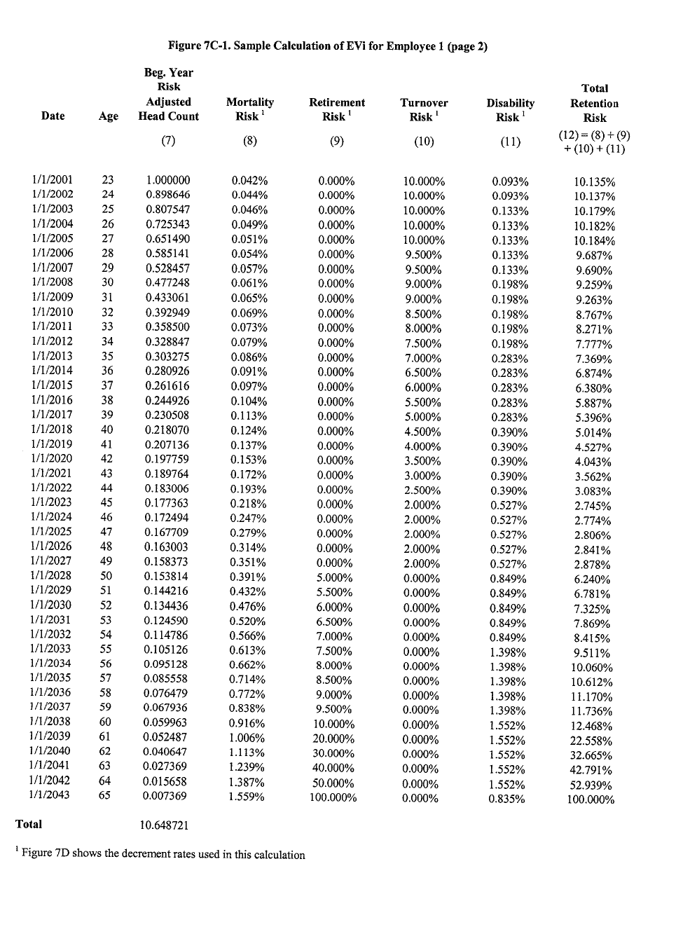

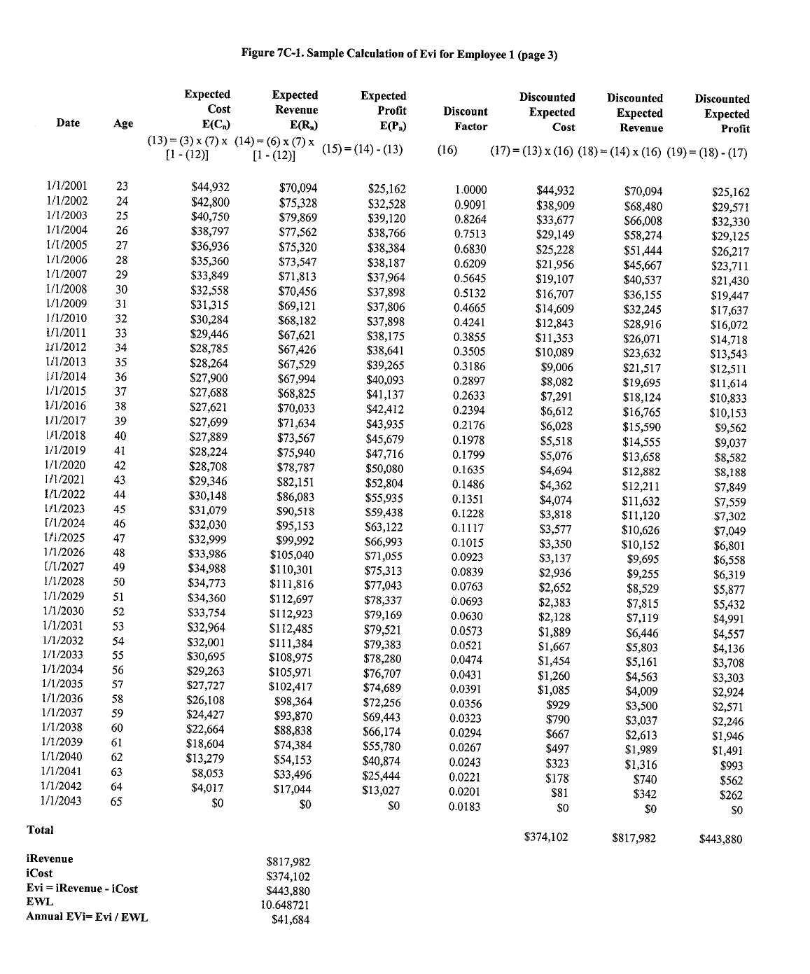

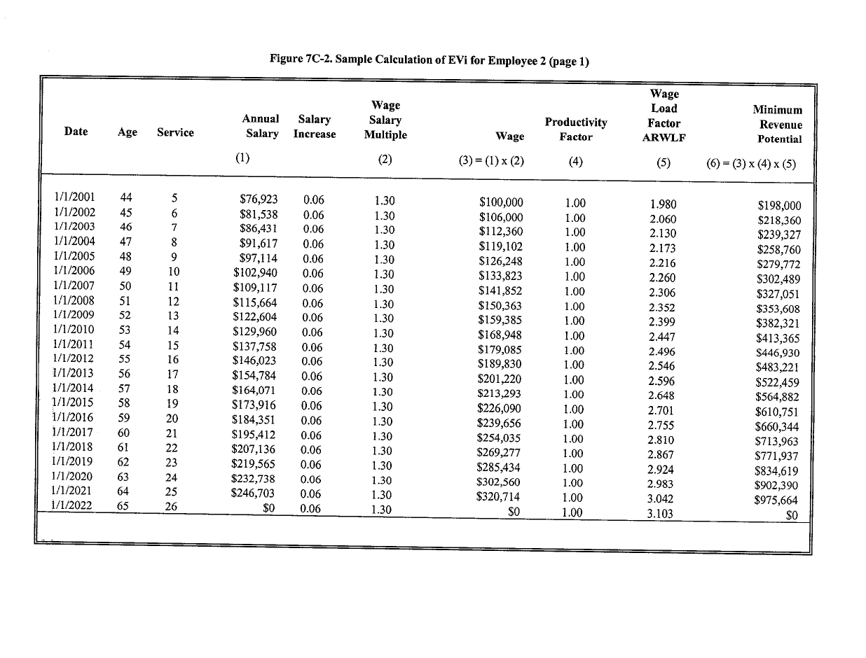

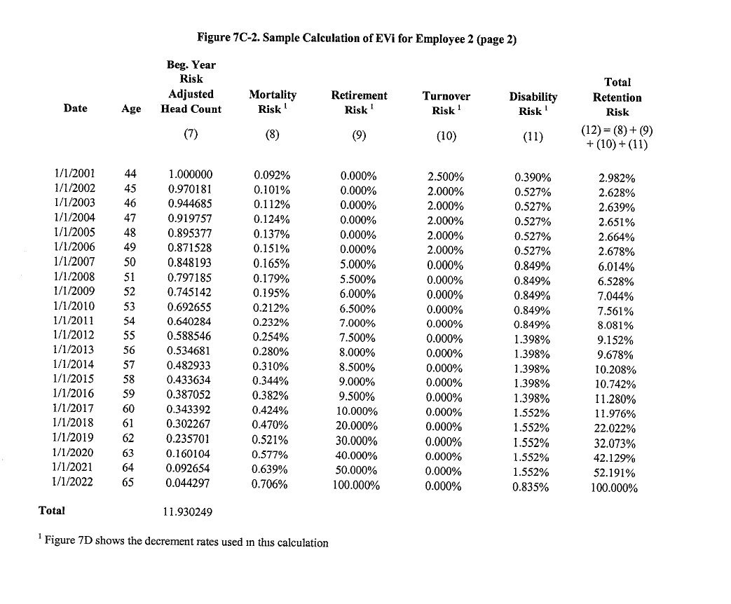

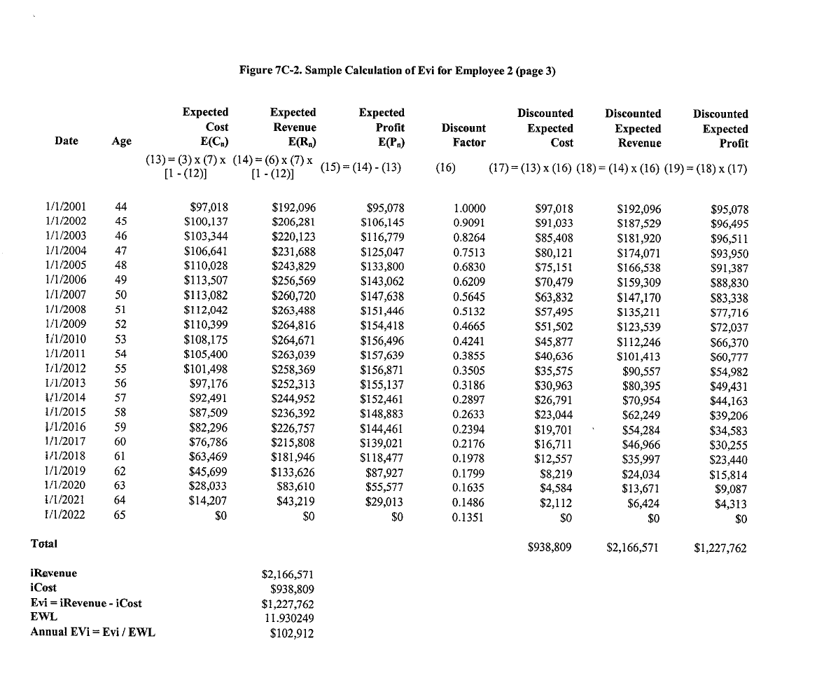

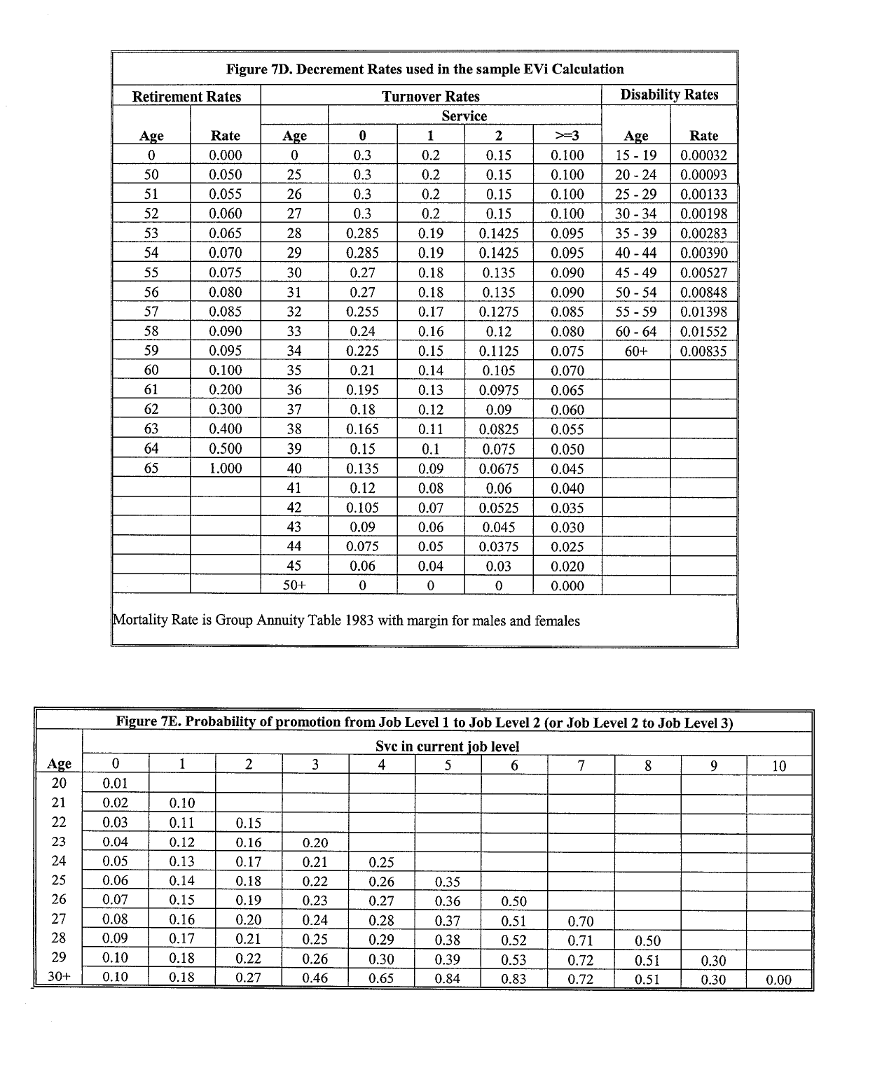

The processing above may be performed with automatic data processing equipment, such as conventional computer processing systems. In accordance with the invention, such computer processing systems may communicate with a database in which group and individual data is stored. The stored data may include the data components described above that will permit the automatic computation of a quantifiable individual valuation term, such as the EVi™ measure described above. The database may include information comprising the data components for individuals, or information from which the data components may be calculated, including time-based low productivity costs associated with departure of the individual from the group and replacement of said individual, time-based vacancy costs, new hire risk cost that includes a computation for expected working lifetime of the individual and of a replacement for the individual, expected revenues generated by the individual, the ARV of the individual, and wage load factor. Both the EVi™ and the Annual EVi™ calculations are illustrated in FIGS. 7C 1-2, described further below.

4. Sample Calculation

FIGS. 7A 1-2 and 7B show the results of processing in accordance with the present invention, illustrating a sample calculation of the individual valuation metric EVi™ for two different individuals, identified as Employee 1 and Employee 2. For purposes of illustration, Wage for Employee 1, the first individual under study, is assumed to be $50,000 annually, while for Employee 2, the second individual, Wage is $100,000 annually. Sample values for date of birth, date of hire, and gender are provided, to complete the example. For purposes of this illustration, Wage includes overhead, administrative costs, benefits, and the like. Therefore, for all employees, Wage is assumed to be 30% additional to the actual pay earned (and paid to) an employee.

The calculation of the ARV component of the EVi™ measure for the first three years is illustrated in FIGS. 7A-1 and 7A-2. These tables show the calculation of the ARV component of the EVi measure for the first three years (for two different individuals), including a calculation for different job levels in years 2 and 3. It should be noted that the RV1, RV2, RV3, and RV4 terms are readily computed once the appropriate data are retrieved from the database and the required precursor calculations are performed, as described above. It should be understood that, although calculation of iCost is not shown in FIGS. 7A-1 and 7A-2, the determination of iCost would be relatively straightforward in view of the description above, and with the iCost value, the EVi™ metric may be easily calculated by Equation 1, which shows that the EVi™ metric is the difference of iRevenue (where iRevenue is given by Wage+ARV) and iCost.

The first illustrated computation in FIGS. 7A-1 and 7A-2 involves Dollar-Based Costs, which are the staffing and separation costs associated with replacing the individual under consideration. These costs can be divided into two groups: those that are dependent on Wage and those that are not, as shown in Row A and Row B. Thus, in performing this computation, the processing system retrieves the wage information and fixed cost information from the database, based on the identified individual under consideration, and carries out the illustrated computation. It should be noted that each employee may incur staffing and separation costs given by a different percentage of Wage and a different fixed amount, depending on his or her respective position in the organization, as illustrated in FIGS. 7A-1 and 7A-2. Thus, Wage-dependent staffing and separation costs for Employee 1 (FIG. 7A-1) in 2001 are $3,500, but the same costs for Employee 2 (FIG. 7A-2) are $10,000, a reflection of their different job levels.

In a similar fashion, Row B shows non-Wage-dependent Dollar-Based Staffing and Separation Costs. Again, the appropriate information is retrieved from the system database for each employee. The amounts will typically depend on the particular organization and the particular employees (positions) under consideration. Thus, for example, for the first year, non-Wage-dependent Dollar-Based Costs for Employee 1 (FIG. 7A-1) are $1,105, while for Employee 2 (FIG. 7A-2) they are equal to $11,400. The processing shown in Row A and Row B illustrates the processing described previously for box 306 of FIG. 3.

Row C, Row D, and Row E of FIGS. 7A-1 and 7A-2 illustrate the Time-Based Low Productivity Cost computation and data that correspond to the processing of box 308 of FIG. 3. As noted above, such values may be the same for all employees, or may be different for each employee. Thus, new hire low productivity (Row C) and pre-separation low productivity (Row D) are different for different employees, but rate of return (Row E) is shown as being the same for Employee 1 (FIG. 7A-1) and Employee 2 (FIG. 7A-2). The Time-Based Vacancy Cost calculation illustrated in Row F corresponds to the processing described for box 310 of FIG. 3. The new hire risk costs associated with the ARV calculation involve the calculations of Row G and Row H, and correspond to the processing of FIG. 3 box 312.

For each year of employment, the ARV components (Row A through Row H of FIGS. 7A-1 and 7A-2) will be computed and will likely have different values for each year of the analysis. It should be understood that FIGS. 7A-1 and 7A-2 show the results of such processing for the first three years, for purposes of illustration. Row K through Row N show the ARV components, and Row O provides the actual ARV number, being the stun of RV1+RV2+RV3+RV4.

FIGS. 7A-1 and 7A-2 also show that ARV as a wage load factor can be computed (Row P) and then an Actuarial Revenue Wage Load Factor (ARWLF) can be derived (Row Q). The ARWLF indicates the individual's contribution to revenue as a multiple of Wage. In this way, the ARWLF can provide a relative ranking of group members in their contribution to revenue. The ranking can be useful in human resource management tasks. FIG. 7B shows how probabilities are used to calculate the weighted average ARWLF. For the purpose of this illustration, there are three different job levels (levels 1, 2, and 3). Based on company statistics or expectations regarding employee promotions, two tables are set up. The first one contains the probabilities that an employee at job level 1 will be promoted to job level 2 based on age and service at job level 1. The second one contains the probabilities that an employee at job level 2 will be promoted to job level 3 based on age and service at job level 2. The set of sample probabilities used in this calculation are shown in FIG. 7E.

Row A shows total of headcounts at each job level, or the probability that the employee is in that job level. Row B shows the calculated probability that the employee is in each job level for years 1 through 3. Row C shows values of ARWLF in each job level for years 1 through 3 as calculated in FIGS. 7A-1 and 7A-2 (row Q). Finally Row C shows the value of the weighted average ARWLF for years 1 through 3. Weighted average ARWLFs are then used in the EVi™ calculation in FIGS. 7C-1 and 7C-2 (column 5).

FIGS. 7C-1 and 7C-2 comprise a set of tables that show the computation of the EVi™ metric using the ARWLF calculation from FIGS. 7A-1 and 7A-2. The following explanation describes the calculations used for Employee 1 in FIG. 7C-1 (entitled “Sample Calculation of EVi for Employee 1”). Each year of the analysis begins on January 1, and Employee 1 is indicated as being twenty-three years of age as of Jan. 1, 2001 (the first year of the analysis). The table indicates that Employee 1 has three years of service with the company at the beginning of the analysis period. The pay amount for Employee 1 is shown in the Annual Salary column, marked (1), and an annual raise in pay of 6% over the time of the study is indicated. If desired, a different set of assumptions may be made about changes in pay over the course of the analysis period. As noted above, a multiple of 1.3 is used to determine Wage, based on employee pay, giving the data in the Wage column (indicated as column (3) in the table). A productivity factor of 1.00 is assumed for all years under the analysis, but as described above in the discussion following Equation 21, the productivity factor pfₙ, (marked as column 4 in the table) for an employee in year n may change for each value of n. For the purpose of this illustration, the simplifying assumption is made that the productivity factor is equal to 1.00.

The next computation shown in the table is the wage load factor, ARWLF, indicated as column 5 in the table. It should be noted that the ARWLF value for the first three years is calculated in FIG. 7B (row C). ARWLF values for the subsequent years are calculated in the same manner as for years 1 through 3. However, they are not presented in this illustration, and for the purpose of simplicity they are assumed to grow at 2% per year after year 3.

In the next column of FIG. 7C-1, the minimum revenue potential of the employee (column 6) is calculated as the result of multiplying Wage by both productivity factor and ARWLF. This derivation is appropriate because an employee's revenue is assumed to be equal to Wage, productivity factor is an adjustment to earning potential in a particular year, and ARWLF is used in this computation as a measure of what the employee can produce, relative to other employees. Hence, this column refers to “potential” value.

The next table of FIG. 7C-1 titled “Sample Calculation of Evi for Employee 1 (page 2)” shows the calculation of the risk adjustment due to probability of decrements. The third column, Beginning Year Risk Adjusted Head Count (column 7 of the table), is an indication for each year n of the probability that the employee will actually still be with the company in year n. It should be apparent that the probability is 1.0 for the first year of the analysis, and reduces thereafter. This type of risk adjustment may be derived from human resource data, or obtained from any other suitable data source such as industry statistics, actuarial tables, etc. For this calculation a set of tables is provided in FIG. 7D. The sum of column 7, excluding the first year headcount, is, according to equation 2, the Expected Working lifetime (ewl), which is equal to 10.6 for employee 1.

The mortality risk (column 8 of the table) is generally available from standard mortality tables and similar data, such as relied upon by life insurance providers. The retirement risk (column 9) is set to zero until the employee first becomes eligible for retirement benefits, generally after age fifty or after some combination of years of age and years of service to the company. Again, human resource data (either company or industry-specific) and studies by actuarial organizations and the like may be used as a source of retirement (column 9), turnover (column 10), and disability (column 11) risks. Lastly, the total retention risk (the probability that the employee will not remain with the company at the beginning of the next year, column 12) is calculated as the sum of the annual risk adjustment factors (columns 8, 9, 10, and 11).

Each succeeding row of FIG. 7C-1 is completed in a similar manner, using the data from FIG. 7B and from preceding rows. For example, the annual salary (column 1) for Employee 1 on Jan. 1, 2002 (age 24) is increased by the assumed annual increase of 6% from the value of the preceding year ($40,769=$38,462×1.06). A similar calculation is performed for Wage (column 3) as of Jan. 1, 2002. Using the new values for pay and Wage, and any other required values from FIG. 7B the subsequent computations are completed for each year until the last year when the employee could retire (assumed to be age 65 for this illustration).

The next table of FIG. 7C-1, titled “Sample Calculation of Evi for Employee 1 (page 3)” show the calculations to determine revenues, costs, and the EVi™ measure in accordance with the invention. Each row of this table makes use of information from columns of the corresponding row of the previous table. That is, just as with the previous table, the respective values for each year of the analysis are computed in turn and the table is completed.

Thus, as described above in conjunction with the discussion Equation 3, the expected cost E(Cₙ) for each year n (column 13) is indicated as Wage (column 3) multiplied by head count risk (column 7) multiplied by the value of [1.0 −(retention risk)], where retention risk is given by column 12. The expected revenue E(Rₙ), in accordance with Equation 21, is given by column 14 of FIG. 7C-1 as minimum potential revenue (column 6) multiplied by head count risk (column 7) multiplied by the value of [1.0 −(retention risk)], where retention risk is given by column 12.

The expected profit E(Pₙ) is then given by column 15, the difference between expected revenue and expected cost. A discount factor (column 16) is determined for each year of the analysis, to provide a present value calculation, and then the discount factor is applied each year to the cost and to the revenue, to produce a discounted expected cost (column 17), a discounted expected revenue (column 18), and a discounted expected profit (column 19).

The sum of all discounted expected cost terms of column 17 then gives a total expected cost term (iCost), and the sum of all discounted expected revenue terms of column 18 gives a total expected revenue term (iRevenue), as shown in the table. The EVi™ measure is then given, as described above in Equation 1 and Equation 24, as iRevenue minus iCost. The employee's Annual EVi term may be obtained as EVi/ewl, per Equation 25 described above. Thus, for Employee 1, the EVi™ measure covering the present time (first year of the analysis) through retirement of Employee 1 at age 65, a span of 45 years of service, is $443,880. A similar calculation for Employee 2 (FIG. 7C-2) shows that $1,227,762 is the EVi™ measure, covering the present time at age 44 through retirement at age 65, a span of 26 years of available service. As described, this EVi™ measure takes account of discount rates, pay earned, and various decrements such as mortality, turnover, disability, retirement, etc. In this way, the EVi™ measure as described herein provides a measure of human capital value for any individual in an organization.

5. The Computer Processing System

The computations described above can advantageously be carried out by a computer data processing system. The fast processing speeds of computers, coupled with the ability to access large amounts of data, permits the technique described herein to be used for determining employee valuations, employee by employee, for very large organizations. The efficiency of such systems therefore makes it possible for large organizations to accurately assess the value of individuals to the organization.

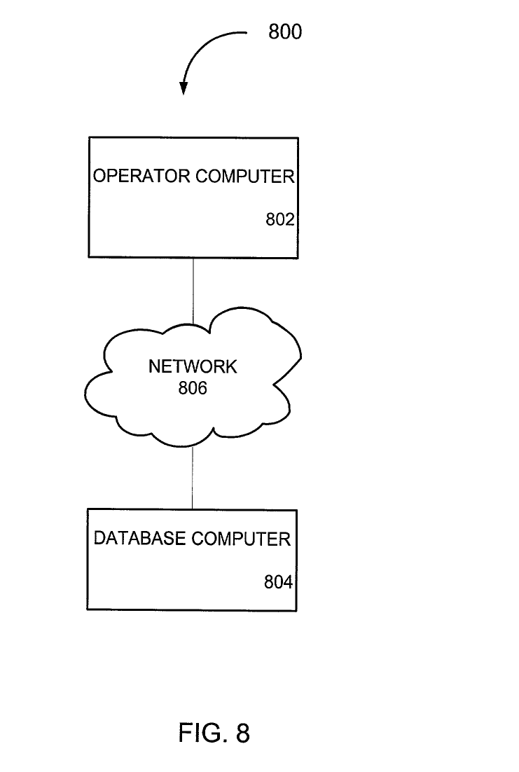

FIG. 8 is a block diagram of a computer system 800 constructed in accordance with the present invention to implement the processing described above. The system includes a user workstation computer 802 from which a system operator provides commands to initiate and control the calculation of EVi™ for one or more individuals under consideration for an organization. The processes described above are executed by the computer 802 according to program instructions stored in program memory of the computer, as described further below. The data to perform the calculations of the EVi™ processing may be received from the operator of the computer 802 and may be retrieved from a data computer 804, to which the operator computer may be connected over a network 806. The network may comprise, for example, a local area network (LAN) or a network such as the Internet. Alternatively, the data may be stored in external storage devices that are accessed by the operator computer 802. Thus, the data computer comprises a database computer of the network 800.

The program instructions performed by the operator computer 802 will automatically access the data needed to carry out the EVi™ metric calculations and to thereby produce a numerical valuation of an individual's contribution to the group or organization. The program instructions may be embodied, for example, in application software that has access to the network databases needed to carry out the EVi™ metric calculations. Some of the data will be dependent on the individual person under consideration, and will require access to employee records. Other data may comprise data assumptions and values that apply over multiple employees.

The values shown in FIGS. 7A-1 and 7A-2 are meant as sample data that may be used in the calculations described above for most organizations. It is to be understood, however, that some organizations may have different cost structures and revenue sources, and therefore different data may apply.

The application program installed on the operator computer 802 as shown in FIG. 8 will be provided with the data needed for computation through any of the various computer data input means described below. The operator computer thereby produces a single numerical result (the EVi™ metric) that quantifies an individual employee's expected contribution to the company or organization. The EVi™ metric calculation can be repeated for each company employee in turn, or for each member of a group or unit in the company under consideration. The numerical result is then easily used to meet a variety of corporate planning needs, such as employee rankings, incentive programs, resource deployment, training programs, and the like.

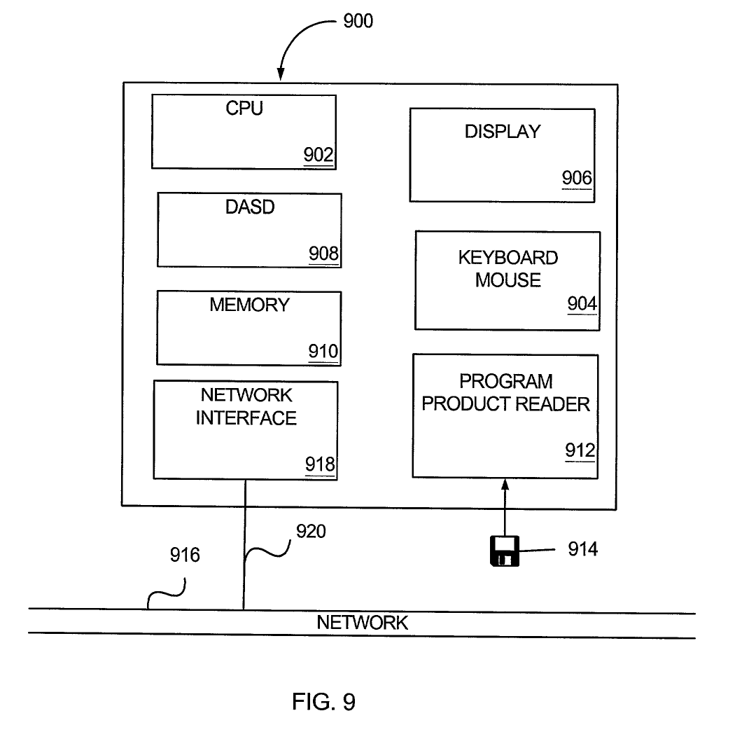

FIG. 9 is a block diagram of an illustrative computer 900 such as might be used to implement the individual valuation processing described above. Both of the computers illustrated in FIG. 8, the operator computer 802 and the database computer 804, may have a construction like that shown in FIG. 9. The computer 900 operates under control of a central processor unit (CPU) 902, such as a “Pentium” microprocessor and associated integrated circuit chips, available from Intel Corporation of Santa Clara, Calif., USA. A computer user can input commands and data, such as data values, from a keyboard 904 and can view inputs and computer output at a display 906. The display is typically a video monitor or flat panel display. The computer 900 also includes a direct access storage device (DASD) 908, such as a hard disk drive. The memory 910 typically comprises volatile semiconductor random access memory (RAM) and may include read-only memory (ROM). The computer preferably includes a program product reader 912 that accepts a program product storage device 914, from which the program product reader can read data (and to which it can optionally write data). The program product reader can comprise, for example, a disk drive, and the program product storage device can comprise removable storage media such as a magnetic floppy disk, a CD-R disc, or a CD-RW disc. The computer 900 may communicate with other computers over the network 916 through a network interface 918 that enables communication over a connection 920 between the network and the computer.

The CPU 902 operates under control of programming steps that are temporarily stored in the memory 910 of the computer 900. The programming steps may include a software program, such as a program that implements the recovery agent. Alternatively, the software program may include an applet or a Web browser plug-in. The programming steps can be received from ROM, the DASD 908, through the program product storage device 914, or through the network connection 920. The storage drive 912 can receive a program product 914, read programming steps recorded thereon, and transfer the programming steps into the memory 910 for execution by the CPU 902. As noted above, the program product storage device can include any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 910 over the network 916. In the network method, the computer receives data including program steps into the memory 910 through the network interface 918 after network communication has been established over the network connection 920 by well-known methods that will be understood by those skilled in the art without further explanation. The program steps are then executed by the CPU.

6. Summary

The processing as described above may be applied to a wide variety of tasks in organizations where quantifiable individual valuation is important. The invention encompasses other novel features and techniques. For example, the invention may provide a method for calculating “new hire risk”, which may be applied to any approach to calculating replacement cost. The addition of “New Hire Risk” may also be applied to the other components. The invention as described above may also be applied to the way in which Time-Based Low Productivity Costs are treated (by applying a factor to elapsed days) vs. Time-Based Vacancy Costs. Moreover, the description above shows that one affects revenues, the other profits.

Another novel aspect of the invention is the way in which a low productivity factor for pre-separation and new hire low productivity for different positions (area under the curve, conversion to an equivalent number of unproductive days) is estimated. In accordance with the invention, revenues may be linked to specific individual contributions or efforts. In an additional novel aspect of the invention, two different people (new and old hires) may be treated in the same way with respect to wages—because, in accordance with the invention, we assume that the existing employee's replacement will be equivalent to the existing employee in terms of his or her knowledge base and skill level, and, based on market demand, the price for these skills will be identical. This assists in the calculation.

In yet another novel aspect of the invention, the valuation processing utilizes revenue and profit proxies for the determination of time-based opportunity costs that are internally consistent and are calculated based on the method itself. In addition, the invention characterizes Wage plus a “value premium” as an expression for the minimum expected revenue contribution. The invention also combines actuarial and traditional economic valuation principles in arriving at the described method (such as using a cost method for Wages, a market method for Revenue, and an income method for New Hire Low Productivity component).

The present invention has been described above in terms of a presently preferred embodiment so that an understanding of the present invention can be conveyed. There are, however, many configurations for quantitative measures of individual valuation not specifically described herein but with which the present invention is applicable. The present invention should therefore not be seen as limited to the particular embodiments described herein, but rather, it should be understood that the present invention has wide applicability with respect to individual valuation systems. All modifications, variations, or equivalent arrangements and implementations that are within the scope of the attached claims should therefore be considered within the scope of the invention.

We claim:

1. A method of computing a measure of individual value to a group of which the individual is a member, the method comprising:
determining an individual cost associated with the individual with respect to the group;
determining an individual revenue associated with the individual cost, for the individual with respect to the group, such that the determined individual revenue includes a computed Actuarial Replacement Value (ARV); and
calculating an individual value, in accordance with the determined individual cost and the determined individual revenue, that quantifies the value of the individual to the group.

2. A method as defined in claim 1, wherein determining individual revenue includes calculating expected revenues generated by the individual while in the group.

3. A method as defined in claim 2, wherein computing ARV includes calculating time-based low productivity costs associated with departure of the individual from the group and replacement of said individual.

4. A method as defined in claim 2, wherein computing ARV includes calculating a time-based vacancy cost associated with departure of the individual from the group and replacement of said individual.

5. A method as defined in claim 2, wherein computing ARV includes calculating a new-hire risk cost that includes the computation of expected working lifetime of the individual and of a replacement for the individual.

6. A method as defined in claim 2, wherein computing ARV includes obtaining data relating to staffing costs and separation costs, productivity costs, vacancy costs, and new-hire risk costs, and then calculating the individual value metric in accordance with the determined individual cost and the determined individual revenue.

7. A method as defined in claim 2, wherein:
determining individual revenue includes calculating expected revenues generated by the individual while in the group; and
computing ARV includes calculating time-based low productivity costs associated with departure of the individual from the group and replacement of the said individual; calculating a time-based vacancy cost associated with departure of the individual from the group and replacement of said individual; and calculating a new-hire risk cost that includes the computation of expected working lifetime of the individual and of a replacement for the individual.

8. A method as defined in claim 7, further including:
determining an iRevenue value, defined as the present value of minimum expected revenues to be earned for the group by the individual under consideration; and
determining an iCost value, defined as the present value of expected wages to be paid by the group to the individual under consideration;
wherein the individual value to the group is determined by the difference of iRevenue and iCost for the individual under consideration.

9. A method as defined in claim 8, further including:
determining an iProfit value for a year n, defined as the difference of expected revenue E(Rₙ) contributed to the group by the individual under consideration and the expected cost E(Cₙ) to the group of the individual under consideration for year n.

10. A method as defined in claim 8, farther including:
determining an annual value of the individual to the group by dividing the difference of iRevenue and iCost by the expected working lifetime of the individual under consideration.

11. A method as defined in claim 1, further including:
computing an Actuarial Revenue Wage Load Factor (ARWLF) that utilizes ARV to provide an ARWLF value for each individual under consideration and to indicate that individual's relative revenue contribution to the group with respect to all other individuals in the group, thereby creating a means of comparing individuals.

12. A system that computes an individual value metric that quantifies the value of an individual to a group of which the individual is a member, the system comprising:
a database in which information about the individual and the group is stored; and
a computer processing system that communicates with the database to retrieve information from which the computer processing system determines an individual cost associated with the individual with respect to the group, determines an individual revenue associated with the individual cost for the individual with respect to the group, such that the computer processing system determines the individual revenue by computing an Actuarial Replacement Value (ARV) and calculates an individual value, in accordance with the determined individual cost and the determined individual revenue, that quantifies the value of the individual to the group.

13. A system as defined in claim 12, wherein the computer processing system determines individual revenue by calculating expected revenues generated by the individual while in the group.

14. A system as defined in claim 12, wherein the computer processing system determines ARV by calculating time-based low productivity costs associated with departure of the individual from the group and replacement of said individual.

15. A system as defined in claim 12, wherein the computer processing system determines ARV by calculating a time-based vacancy cost associated with departure of the individual from the group and replacement of said individual.

16. A system as defined in claim 12, wherein the computer processing system determines ARV by calculating a new-hire risk cost that includes a valuation for expected working lifetime of the individual and for expected working lifetime of a replacement for the individual.

17. A system as defined in claim 12, wherein the computer processing system computes ARV by obtaining data relating to staffing costs and separation costs, productivity costs, vacancy costs, and new-hire risk costs, and then calculates the individual value metric in accordance with the determined individual cost and the determined individual revenue.

18. A system as defined in claim 12, wherein the computer processing system:
determines individual revenue by calculating expected revenues generated by the individual while in the group; and
computes ARV by calculating time-based low productivity costs associated with departure of the individual from the group and replacement of the said individual; calculating a time-based vacancy cost associated with departure of the individual from the group and replacement of said individual; and calculating a new-hire risk cost that includes the computation of expected working lifetime of the individual and of a replacement for the individual.

19. A system as defined in claim 17, wherein the computer processing system computes individual value by:
determining an iRevenue value, defined as the present value of minimum expected revenues to be earned for the group by the individual under consideration; and
determining an iCost value, defined as the present value of expected wages to be paid by the group to the individual under consideration;
wherein the individual value to the group is determined by the difference of iRevenue and iCost for the individual under consideration.

20. A system as defined in claim 18, wherein the computer processing system further determines individual valuation by:
determining an iProfit value for a year n, defined as the difference of expected revenue E(Rₙ) contributed to the group by the individual under consideration and the expected cost E(Cₙ) to the group of the individual under consideration for year n.

21. A system as defined in claim 18, wherein the computer processing system further determines an annualized metric for the individual value to the group by dividing the difference of iRevenue and iCost by the expected working lifetime of the individual under consideration.

22. A program product for use in a computer that executes program steps recorded in a computer-readable medium to perform a method of computing a measure of individual value to a group of which the individual is a member, the program product comprising:
a recordable medium;
computer-readable instructions recorded on the recordable media, comprising instructions executable by the computer to perform a method comprising:
determining an individual cost associated with the individual with respect to the group;
determining an individual revenue associated with the individual cost, for the individual with respect to the group, such that the determined individual revenue includes a computed Actuarial Replacement Value (ARV); and
calculating an individual value, in accordance with the determined individual cost and the determined individual revenue, that quantifies the value of the individual to the group.

23. A program product as defined in claim 22, wherein the computer-executed method of determining individual revenue includes calculating expected revenues generated by the individual while in the group.

24. A program product as defined in claim 22, wherein the computer-executed method of computing ARV includes calculating time-based low productivity costs associated with departure of the individual from the group and replacement of said individual.

25. A program product as defined in claim 22, wherein the computer-executed method of computing ARV includes calculating a time-based vacancy cost associated with departure of the individual from the group and replacement of said individual.

26. A program product as defined in claim 22, wherein the computer-executed method of computing ARV includes calculating a new-hire risk cost that includes computation of a valuation for expected working lifetime of the individual and of a replacement for the individual.

27. A program product as defined in claim 22, wherein the computer-executed method of computing ARV includes obtaining data relating to staffing costs and separation costs productivity costs, vacancy costs, and new-hire risk costs, and then calculating the individual value metric in accordance with the determined individual cost and the determined individual revenue.

28. A program product as defined in claim 22, wherein the method performed by the computer in executing the computer-readable instructions further includes:
determining individual revenue by calculating expected revenues generated by the individual while in the group; and
computing ARV by calculating time-based low productivity costs associated with departure of the individual from the group and replacement of the said individual; calculating a time-based vacancy cost associated with departure of the individual from the group and replacement of said individual; and calculating a new-hire risk cost that includes the computation of expected working lifetime of the individual and of a replacement for the individual.

29. A program product as defined in claim 28, wherein the method performed by the computer in executing the computer-readable instructions further includes:
determining an iRevenue value, defined as the present value of minimum expected revenues to be earned for the group by the individual under consideration; and
determining an iCost value, defined as the present value of expected wages to be paid by the group to the individual under consideration;
wherein the individual value to the group is determined by the difference of iRevenue and iCost for the individual under consideration.

30. A program product as defined in claim 28, wherein the method performed by the computer in executing the computer-readable instructions further includes:
determining an iProfit value for a year n, defined as the difference of expected revenue E(Rₙ) contributed to the group by the individual under consideration and the expected cost E(Cₙ) to the group of the individual under consideration for year n.

31. A program product as defined in claim 28, wherein the method performed by the computer in executing the computer-readable instructions further includes determining an annualized metric for the individual value to the group by dividing the difference of iRevenue and iCost by the expected working lifetime of the individual under consideration.

32. A method for computing an Actuarial Replacement Value of an individual to a group of which the individual is a member, the method comprising:
calculating a time-based low productivity costs associated with departure of the individual from the group and replacement of the individual;
calculating a time-based vacancy cost associated with departure of the individual from the group and replacement of the individual;
calculating a new-hire risk cost that includes the computation of expected working lifetime of the individual and of a replacement for the individual;
obtaining data relating to staffing costs and separation costs, productivity costs, vacancy costs, and new-hire risk costs;
calculating time-based low productivity costs associated with departure of the individual from the group and replacement of the individual; and
combining the above-derived quantities.
